(19) United States
(12) Patent Application Publication
(10) Pub. No.: US 2008/0272988 A1
(43) Pub. Date: Nov. 6, 2008

(54) PLASMA DISPLAY PANEL

(75) Inventor: Jung-Suk SONG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/111,348

(22) Filed: Apr. 29, 2008

(30) Foreign Application Priority Data
May 2, 2007 (KR) 2007-42756

(51) Int. Cl. G09G 3/28

(52) U.S. Cl. 345/60

(57) ABSTRACT

A plasma display panel (PDP) having electrodes with an improved structure to prevent cutting defects thereof, the PDP including: a pair of substrates including display regions displaying images and non-display regions that do not display images, wherein the substrates are arranged to face each other and spaced apart from each other; barrier ribs corresponding to the display regions and defining discharge cells where a gas discharge is generated, the barrier ribs being arranged between the substrates; a phosphor layer respectively disposed in the discharge cells; a plurality of electrodes, each including an electrode portion provided in the display regions of the substrates, an oblique line portion provided at a side of the non-display regions and electrically connected to the electrode portion, and a terminal portion electrically connected to the oblique line portion, the terminal portion including a groove formed therein; and a dielectric layer formed on the substrates.

### CROSS-REFERENCE TO RELATED APPLICATION

This application claims the benefit of Korean Application No. 2007-42756, filed May 2, 2007 in the Korean Intellectual Property Office, the disclosure of which is incorporated herein by reference.

### BACKGROUND OF THE INVENTION

1. Field of the Invention

Aspects of the present invention relate to a plasma display panel, and more particularly, to a plasma display panel having an improved structure to prevent cutting defects of electrodes.

2. Description of the Related Art

A plasma display panel is a flat panel display that reproduces images using gas discharges. Since the plasma display panel has a thin structure with a large screen that displays high quality images, much research has been conducted thereon.

The plasma display panel includes a first substrate and a second substrate, barrier ribs arranged between the first and second substrates; a discharge gas, a phosphor layer, and electrodes to which a voltage is applied. The first and second substrates face each other and are spaced apart. The barrier ribs define discharge cells in which gas discharges are generated. The discharge gas is filled in the discharge cells to generate the gas discharges. The phosphor layer is coated on surfaces of the discharge cells. The gas discharges are generated in the discharge cells by a direct current or alternate current voltage applied between the electrodes, and ultraviolet rays emitted from the discharge gas excites the phosphor layer to emit visible light, thereby realizing images.

The electrodes in the plasma display panel include sustaining electrodes formed in the first substrate and address electrodes formed in the second substrate. The sustaining electrodes include common electrodes and scanning electrodes. The address electrodes generate an address discharge according to address voltages applied between the scanning electrodes and the address electrodes.

FIG. 1 is a plane view illustrating electrodes and contact terminals of a conventional plasma display panel. Referring to FIG. 1, the sustaining electrodes or the address electrodes extend toward a terminal region C1 outside a display region A1, and are connected to a signal transfer unit 120 (such as a flexible printed circuit or a chip on film) in the terminal region C1 to receive driving voltages from a driving circuit substrate (not shown). A connection region B1 is formed between the display region A1 and the terminal region C1.

Accordingly, the sustaining electrodes include electrode portions 111 formed at a pitch P1 in the display region A1, terminal portions 113 formed at a pitch P2 shorter than the pitch P1, and oblique line portions 112 formed in the connection region B1 to connect the electrode portions 111 to the terminal portions 113 in symmetric oblique lines at a gradually reducing pitch.

As described above, the pitch P2 between the electrodes in the terminal portions 113 is reduced because the signal transfer unit 120 is continuously disposed at one edge of the first or second substrate 110 and, thus, it is not possible to precisely connect the signal transfer unit 120 to the terminal portion 113 of the electrodes. In other words, the signal transfer unit 120 must be mounted in the terminal region C1 while being divided into multiple regions. Furthermore, a spare space to avoid interactive interference between the multiple regions of the signal transfer unit 120 is required, such that the pitch P2 between the electrodes in the terminal portion 113 is reduced.

However, when the number of the electrodes including the oblique line portions 112 is increased in order to extend the display region A1 or to realize high quality images in order to efficiently use the first or second substrate 110, the pitch between the electrodes in the portion of the oblique line portions 112 near the terminal portion 113 is reduced even more.

Thus, for the above described reasons, the designing of electrodes between the oblique line portions 112 and the terminal portions 113 is difficult as defects (such as a short circuit of the oblique line portions 112) may be generated during the manufacturing of the electrodes, particularly during an exposure and developing process. Also, when cutting the terminal portions 113, the terminal portions 113 may not be properly cut off, thereby creating the possibility of generating cutting defects.

As described above, it is difficult to extend the display region A1. Accordingly, the substrates cannot be efficiently used and it is difficult to manufacture a plasma display panel for realizing high quality images according to the conventional art.

### SUMMARY OF THE INVENTION

Aspects of the present invention provide a plasma display panel including electrodes having an improved structure to prevent cutting defects thereof.

According to an aspect of the present invention, there is provided a plasma display panel including: a first substrate and a second substrate facing each other and spaced apart from each other, the first substrate including display regions that display images and non-display regions that do not display images; barrier ribs corresponding to the display regions and defining discharge cells where a gas discharge is generated, wherein the barrier ribs are arranged between the first substrate and the second substrate; a phosphor layer respectively disposed in each of the discharge cells; a plurality of electrodes, each including an electrode portion provided in at least one of the display regions of the first substrate, an oblique line portion provided at a side of the non-display regions and electrically connected to the electrode portion, and a terminal portion electrically connected to the oblique line portion, and including a groove formed therein; and a dielectric layer formed on the substrates.

The groove may be provided on a cut off area of each terminal portion from which the terminal portions are cut.

The pitch between the terminal portions may be smaller than the pitch between the electrode portions.

The second substrate may include sustaining electrodes to generate a gas discharge in the discharge cells and including common electrodes and scanning electrodes.

The common electrodes may be extended in a first direction, and the scanning electrodes may be extended in a second direction that crosses the first direction.

The common electrodes and the scanning electrodes may be extended substantially parallel to each other, and the plurality of electrodes may be address electrodes extended to cross the direction in which the common electrodes and the scanning electrodes are extended.

According to another aspect of the present invention, there is provided a plasma display panel including: a first substrate and a second substrate facing each other; light emitting cells partitioned by barrier ribs arranged in display regions of the first substrate and the second substrate; a phosphor respectively coated in the light emitting cells; a discharge gas sealed in the light emitting cells; sustaining electrodes extending across the light emitting cells in a first direction; address electrodes extending across the light emitting cells in a second direction that crosses the first direction; at least one short bar provided at a side of the address electrodes and extending in a third direction that crosses second direction; a first dielectric layer to cover the sustaining electrodes; and a second dielectric layer to cover the address electrodes, wherein the side of the address electrodes on which the short bar is provided has a smaller width than another side of the address electrodes.

Each address electrode may include: an electrode portion located in the display region; a terminal portion located in a terminal region outside of the display region and connected to the short bar; and an oblique line portion connecting the electrode portion and the terminal portion, wherein a first area of the terminal portion has a smaller width than a second area of the terminal portion.

The first area of the terminal portion may be a cut off area of the address electrode from which the address electrode is cut.

The first area may be provided closer to the short bar than the second area.

According to yet another aspect of the present invention, there is provided a substrate included in a plasma display panel, the substrate including: display regions that display images; non-display regions that do not display images; and a plurality of electrodes, each comprising an electrode portion provided in at least one of the display regions, an oblique line portion provided at a side of the non-display regions and electrically connected to the electrode portions, and a terminal portion electrically connected to the oblique line portions and including a groove formed therein.

According to still another aspect of the present invention, there is provided an electrode extending across display and non-display regions of a substrate on a plasma display panel, the electrode including: an electrode portion provided in at least one of the display regions; an oblique line portion provided at a side of the non-display regions and electrically connected to the electrode portion; and a terminal portion electrically connected to the oblique line portion and including a groove formed therein.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plane view illustrating electrodes and contact terminals of a conventional plasma display panel;

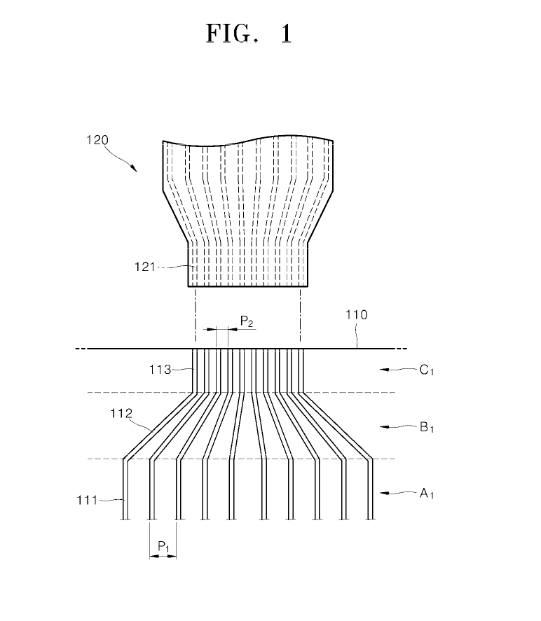

FIG. 2 is a partial separate perspective view illustrating a plasma display panel according to an embodiment of the present invention;

FIG. 3 is a partial separate perspective view illustrating electrodes and contact terminals of the plasma display panel of FIG. 2; and

FIG. 4 is a schematic view showing a cutting process of a short bar and electrodes of FIG. 3.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

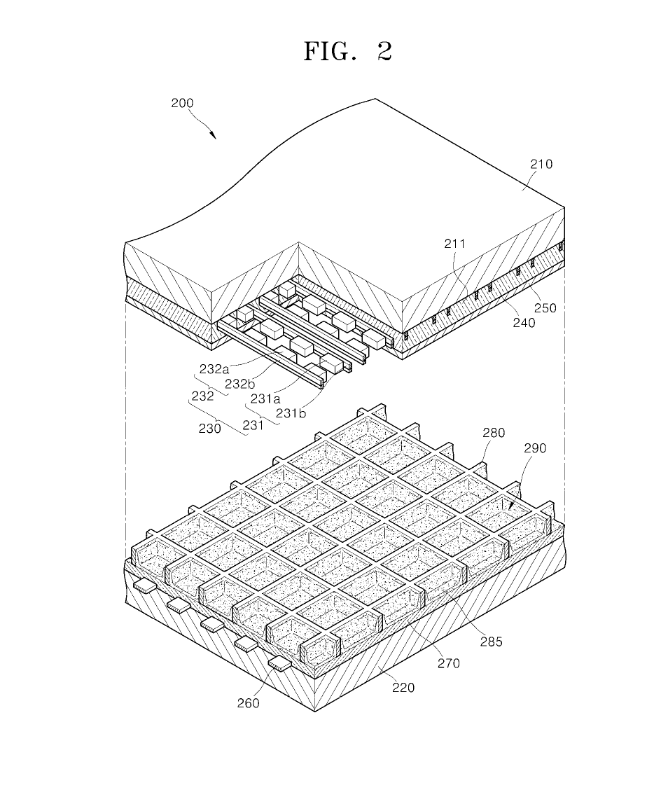

FIG. 2 is a partial separate perspective view illustrating a plasma display panel 200 according to an embodiment of the present invention. Referring to FIG. 2, the plasma display panel 200 includes a first substrate 210, a second substrate 220, barrier ribs 280, a discharge gas (not shown), a phosphor layer 285, and electrodes 230 and 260 to which a voltage is applied. The first substrate 210 and the second substrate 220 are spaced apart from each other and disposed parallel to each other. The barrier ribs 280 are provided between the first substrate 210 and the second substrate 220, and define discharge cells 290 in which a gas discharge is generated. The discharge gas is filled in the discharge cells 290 to generate the gas discharge. The phosphor layer 285 is coated on surfaces in the discharge cells 290. The first substrate 210 is transparent and may be formed of glass.

A pair of sustaining electrodes 230 including a common electrode 231 and a scanning electrode 232 is disposed on the first substrate 210. The common electrode 231 includes a transparent electrode 231a and a bus electrode 231b. Similarly, the scanning electrode 232 also includes a transparent electrode 232a and a bus electrode 232b. However, aspects of the present invention are not limited thereto. For example, the common electrode 231 and the scanning electrode 232 may include only the bus electrodes 231b and 232b without the transparent electrodes 231a and 232a. When the common electrode 231 and the scanning electrode 232 include only the bus electrodes 231b and 232b, the common electrode 231 and the scanning electrode 232 may be formed as a minute bus electrode group. Furthermore, while the sustaining electrode pair 230 in the current embodiment of is disposed on the first substrate 210, it is understood that the electrode pair 230 may also be spaced apart from the first substrate 210.

The transparent electrodes 231a and 232a are separated for each discharge cell 290 and bonded to the bus electrodes 231b and 232b. Furthermore, the transparent electrodes 231a and 232a may be formed of, for example, indium tin oxide (ITO). While the transparent electrodes 231a and 232a in the current embodiment are separated for each discharge cell 290, aspects of the present invention are not limited thereto. For example, the transparent electrodes 231a and 232a may be provided continuously across the discharge cells 290.

The bus electrodes 231b and 232b may be provided above the barrier ribs 280 and may be spaced apart from upper ends of the barrier ribs 280. Also, a space between a pair of the bus electrodes 231b and 232b and another neighboring pair of the bus electrodes 231b and 232b corresponds to a non-discharge region 211. Although not shown, a black mattress layer may be formed in the non-discharge region 211.

A first dielectric layer 240 is disposed on the first substrate 210 to cover the sustaining electrode pair 230. Thus, the first dielectric layer 240 prevents direct conduction between neighboring common electrodes 231 and scanning electrodes 232 during a discharge, prevents charge particles from directly colliding with the sustaining electrode pair 230 and damaging the sustaining electrode pair 230, and accumulates wall charges by inducing charged particles. A dielectric material (such as PbO, B₂O₃, SiO₂, etc.) is used for the dielectric layer 240.

A protection layer 250 formed of MgO and/or the like is formed under the first dielectric layer 240. The protection layer 250 prevents the sustaining electrode pairs 230 from being damaged by sputtering of plasma particles, and emits a large amount of secondary electrons to reduce discharge voltages.

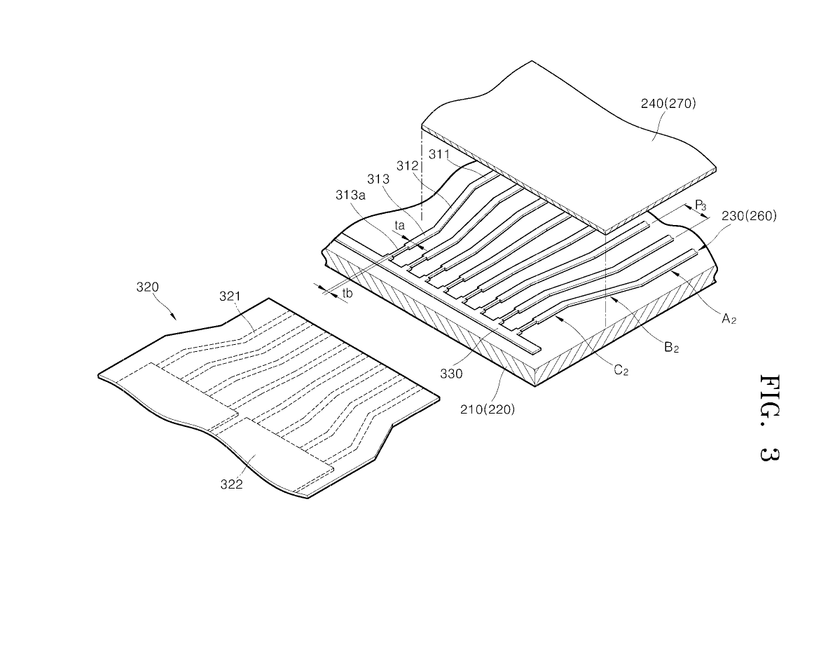

Address electrodes 260 are provided on the second substrate 220. Together with the scanning electrodes 232, the address electrodes 260 perform an address discharge. The address electrodes 260 generate an address discharge in order to make a main discharge between the scanning electrode 232 and the common electrode 231 take place more easily, and more specifically, to reduce the voltage for generating the main discharge. The structure of end portions of the address electrodes 260 will be described in more detail with reference to FIG. 3. A second dielectric layer 270 is provided on the address electrodes 260, and the second dielectric layer 270 protects the address electrodes 260.

Although the address electrodes 260 and the second dielectric layer 270 are included in the plasma display panel 200 according to the illustrated embodiment, aspects of the present invention are not limited thereto. For example, the plasma display panel 200 may not include the address electrodes 260 and the second dielectric layer 270. That is, when the address electrodes 260 are not included in the plasma display panel 200, a voltage for selecting the discharge cells 290 can be applied between the common electrodes 231 and the scanning electrodes 232 by arranging the common electrode 231 and the scanning electrode 232 to cross each other.

The barrier ribs 280 are provided on the second dielectric layer 270 to prevent electrical and optical cross talk between discharge cells 290. The barrier ribs 280 are provided such that a cross-section of the discharge cells 290 is a quadrangle, although aspects of the present invention are not limited thereto. For example, the cross-section may have various other shapes (such as a triangular shape, an pentagonal shape, an oval shape, etc.).

The phosphor layer 285 includes components receiving ultraviolet rays to emit visible light. Specifically, a red phosphor layer formed in red light emitting discharge cells includes a phosphor such as Y(V,P)O4:Eu or the like, a green phosphor layer formed in green light emitting discharge cells includes a phosphor such as Zn₂SiO₄:Mn or the like, and a blue phosphor layer formed in blue light emitting discharge cells includes a phosphor such as BAM:Eu or the like.

After sealing the first substrate 210 and the second substrate 220, the inner space of the assembled plasma display panel 200 is filled with air. Thus, the air in the assembled plasma display panel 200 is completely discharged to replace the air with an appropriate discharge gas to improve the discharge efficiency. A mixed gas (such as Ne—Xe, He—Xe, He—Ne—Xe, etc.) can be used as the discharge gas.

FIG. 3 is a partial separate perspective view illustrating electrodes and contact terminals of the plasma display panel 200 of FIG. 2. Referring to FIG. 3, the first substrate 210 or the second substrate 220 includes a display region A2 and non-display regions B2 and C2. The non-display regions B2 and C2 include a terminal region C2 provided on the outermost side of the substrate 210 or 220 and connected to electrodes 230 or 260 and external terminals, and a connection region B2 provided between the display region A2 and the terminal region C2.

The electrodes 230 or 260 (sustaining electrodes 230 or address electrodes 260 depending on the substrate 210 or 220) are provided in the divided regions A2 through C2 (specifically, from the display region A2, passing the connection region B2, and extending to the terminal region C2). Furthermore, the electrodes 230 or 260 are electrically connected to wiring portions 321 of a signal transfer unit 320 (such as a flexible printed circuit or a chip on film).

In detail, the electrodes 230 or 260 are arranged at predetermined intervals on the substrate 210 or 220. The electrodes 230 or the 260 include electrode portions 311 provided in the display region A2, oblique line portions 312 provided in the connection region B2, and terminal portions 313 provided in the terminal region C2. The electrode portions 311, the oblique line portions 312, and the terminal portions 313 of the electrodes 230 or 260 are provided as a single body on the same plane of the substrates 210 and 220.

In other words, all of the electrode portions 311, the oblique line portions 312, and the terminal portions 313 of the electrodes 230 or 260 are provided at the same time by pattern printing. The oblique line portions 312 of the electrodes 230 or 260 are arranged symmetrically to the left and to the right, as illustrated in FIG. 3.

Also, the pitch between each of the terminal portions 313 of the electrodes 230 or 260 is narrower than the pitch between each of the electrode portions 311. Thus, a spare space is provided on the substrate 210 or 220 and the signal transfer units 320 can be spaced apart from each other, thereby preventing interference between the signal transfer units 320.

Here, grooves 313a are provided in the terminal portions 313. In detail, when manufacturing a plasma display panel 200 according to the conventional art, terminal portions are not cut off properly, resulting in cutting defects. In contrast, according to aspects of the present invention, a groove 313a is provided in a portion of each of the terminal portions 313 so that the terminal portions 313 can be cut off easily.

As illustrated in FIG. 3, a width tb of the groove 313a of the terminal portions 313 is narrower than a width ta of the rest of the terminal portions 313. Also, a short bar 330 is provided on the outer ring of the terminal portions 313 to cross the extension direction of the electrodes 230 or 260. The electrodes 230 or 260 and the short bar 330 may be provided as a single body and can be separated later in an additional cutting process. As the groove 313a of each terminal portion 313 is cut off, the electrodes 230 or 260 and the short bar 330 can be cut off easily.

Thus, the electrodes 230 or 260 and the short bar 330 are spaced apart in predetermined intervals from each other, so that the occurrence of a short circuit therebetween can be prevented. The short bar 330 connects the electrodes 230 or 260 so that an aging process can be performed more easily, and also protects the terminal portions 313 of the electrodes 230 or 260 during a forming process of barrier ribs.

Meanwhile, a dielectric layer 240 or 270 is coated on the substrate 210 or 220 to cover at least a portion of the terminal portions 313 and the oblique line portions 312 of the electrodes 230 or 260. The dielectric layer 240 or 270 includes a display region A2 and a connection region B2, although aspects of the present invention are not limited thereto. For example, the dielectric layer 240 or 270 may be extended to the terminal region C2.

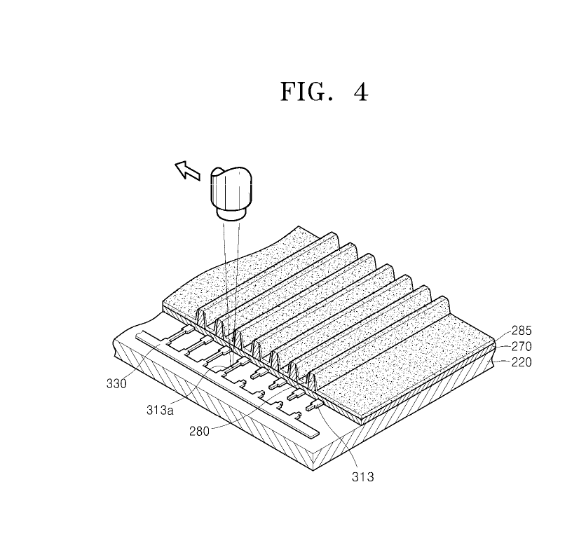

FIG. 4 is a schematic view showing a cutting process of the short bar 330 and the electrodes 230 or 260 of FIG. 3. Referring to FIG. 4, the short bar 330 is provided as a single body with the electrodes 230 or 260 on the substrate 210 or 220, and may be, for example, formed together with the electrodes 230 or 260.

The short bar 330 and the electrodes 230 or 260 provided as a single body are separated by an additional cutting process when the aging process is completed. The cutting process can be, as illustrated in FIG. 4, performed by irradiating a laser beam onto the groove 313a of the electrodes 230 or 260 to cut the irradiated end portions. Accordingly, the electrodes 230 or 260 and the short bar 330 are cut along a cross-section thereof.

Here, the width of the groove 313a of the terminal portions 313 is narrower than the rest of the terminal portions 313. Thus, time and cost can be reduced in the cutting process using laser irradiation. Also, cutting defects are reduced, thereby increasing product reliability.

Hereinafter, the operation of the PDP 200 according to an embodiment of the present invention will be described in detail. First, when a voltage is applied from an external power supply to the signal transfer unit 320, the terminal portions 313, the oblique line portions 312, and the electrode portions 311, sequentially, an address discharge is generated by the address electrodes 260 and the scanning electrode 232, and a sustaining discharge is generated by the scanning electrode 232 and the common electrode 231. As the energy potential of the discharge gas that is excited during the sustaining discharge is lowered, ultraviolet rays are emitted. The ultraviolet ray excites a phosphor of the phosphor layer 285 coated in the discharge cells 290. Furthermore, as the energy potential of the excited phosphor is lowered, visible light is emitted. The emitted visible light is projected to the first substrate 210 and emitted to the outside, forming an image that a user can recognize.

According to aspects of the present invention, cutting defects of electrodes in a plasma display panel can be prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel comprising:
a first substrate and a second substrate facing each other and spaced apart from each other, the first substrate comprising display regions that display images and non-display regions that do not display images;
barrier ribs defining discharge cells where a gas discharge is generated, wherein the barrier ribs are arranged between the first substrate and the second substrate;
phosphor layers respectively disposed in the discharge cells; and
a plurality of electrodes, each comprising an electrode portion provided in at least one of the display regions of the first substrate, an oblique line portion provided at a side of the non-display regions and electrically connected to the electrode portion, and a terminal portion electrically connected to the oblique line portion and including a groove formed therein.

2. The plasma display panel as claimed in claim 1, further comprising a first dielectric layer provided on the first substrate and/or a second dielectric layer provided on the second substrate.

3. The plasma display panel as claimed in claim 1, wherein the groove is provided on a cut off area of each terminal portion from which the terminal portion is cut.

4. The plasma display panel as claimed in claim 1, wherein a pitch between each of the terminal portions is smaller than a pitch between each of the electrode portions.

5. The plasma display panel as claimed in claim 1, wherein the second substrate comprises:
sustaining electrodes including common electrodes and scanning electrodes to generate a gas discharge in the discharge cells.

6. The plasma display panel as claimed in claim 5, wherein the common electrodes extend in a first direction, and the scanning electrodes extend in a second direction that crosses the first direction.

7. The plasma display panel as claimed in claim 5, wherein the common electrodes extend in a first direction and the scanning electrodes extended in a second direction substantially parallel to the first direction.

8. The plasma display panel as claimed in claim 7, wherein the plurality of electrodes is address electrodes that extend in a third direction that crosses the first and second directions.

9. The plasma display panel as claimed in claim 1, wherein the plurality of electrodes is sustaining electrodes that generate a gas discharge in the discharge cells.

10. The plasma display panel as claimed in claim 9, wherein the second substrate comprises address electrodes to generate an address discharge.

11. The plasma display panel as claimed in claim 1, wherein a width of the groove is less than a width of the oblique line portion of each electrode.

12. The plasma display panel as claimed in claim 1, further comprising a short bar connected to the grooves.

13. The plasma display panel as claimed in claim 5, wherein the common electrodes and the scanning electrodes each comprise a transparent electrode and a bus electrode.

14. A plasma display panel comprising:
a first substrate and a second substrate facing each other;
light emitting cells partitioned by barrier ribs arranged in display regions of the first substrate and the second substrate;
a phosphor respectively coated in the light emitting cells;
a discharge gas sealed in the light emitting cells;
sustaining electrodes extending across the light emitting cells in a first direction;
address electrodes extending across the light emitting cells in a second direction that crosses the first direction;
at least one short bar provided at a side of the address electrodes and extending in a third direction that crosses the second direction;
a first dielectric layer to cover the sustaining electrodes; and
a second dielectric layer to cover the address electrodes,
wherein the side of the address electrodes on which the at least one short bar is provided has a smaller width than another side of the address electrodes.

15. The plasma display panel as claimed in claim 14, wherein each address electrode comprises:
an electrode portion located in the display region;
a terminal portion located in a terminal region outside of the display region and connected to the at least one short bar; and
an oblique line portion connecting the electrode portion and the terminal portion,
wherein a first area of the terminal portion has a smaller width than a second area of the terminal portion.

16. The plasma display panel as claimed in claim 15, wherein the first area of the terminal portion is a cut off area of the address electrode from which the address electrode is cut.

17. The plasma display panel as claimed in claim 15, wherein the first area of the terminal portion is closer to the at least one short bar than the second area of the terminal portion.

18. A substrate included in a plasma display panel, the substrate comprising:
display regions that display images;
non-display regions that do not display images; and
a plurality of electrodes, each comprising an electrode portion provided in at least one of the display regions, an oblique line portion provided at a side of the non-display regions and electrically connected to the electrode portions, and a terminal portion electrically connected to the oblique line portions and including a groove formed therein.

19. The substrate as claimed in claim 18, wherein the groove is provided on a cut-off area of each terminal portion from which the terminal portions are cut.

20. The substrate as claimed in claim 18, wherein a width of the groove is less than a width of the oblique line portion of each electrode.
